(19) United States
(12) Patent Application Publication
(10) Pub. No.: US 2008/0106917 A1
(43) Pub. Date: May 8, 2008

(54) Variable edge modulation in a switching regulator

(76) Inventor: James Holt, Los Altos, CA (US)

Correspondence Address: SIDLEY AUSTIN LLP, 555 CALIFORNIA STREET, SUITE 2000, SAN FRANCISCO, CA, 94104-1715, US

(21) Appl. No.: 11/592,092

(22) Filed: Nov. 2, 2006

(51) Int. Cl. H02M 3/337

(52) U.S. Cl. 363/26

(57) ABSTRACT

In one embodiment, in a power converter system having a load, a method is provided for varying the type of modulation employed for a pulse width modulation (PWM) signal. The method includes the following: monitoring the load of the power converter system; using leading edge modulation for the PWM signal under light load condition; and using trailing edge modulation for the PWM signal under heavy load condition; thereby optimizing operation of the power converter system.

### BACKGROUND

1. Field of Invention

The present invention relates to power converters, and more particularly to, to variable edge modulation in a switching regulator.

2. Description of Related Art

Power converters are essential for many modern electronic devices. Among other capabilities, power converters can adjust voltage level downward (buck converter) or adjust voltage level upward (boost converter). Power converters may also convert from alternating current (AC) power to direct current (DC) power, or vice versa. Power converters are typically implemented using one or more switching devices, such as transistors, which are turned on and off to deliver power to the output of the converter. Control circuitry is provided to regulate the turning on and off of the switching devices, and thus, these converters are known as “switching regulators” or “switching converters.” The power converters may also include one or more capacitors or inductors for alternately storing and outputting energy.

Pulse width modulation (PWM) is a technique which is commonly employed to vary the width of the pulse in a periodic signal for turning on and off the switching devices in a power converter. With PWM controlled regulators, the frequency is held constant and the width of each pulse is varied to form a fixed-frequency, variable-duty cycle operation. The output of the PWM circuitry is used to control the switching of switching devices.

Most PWM switching regulators modulate only one edge of each output pulse, allowing the other edge of each pulse (and thus switching time) to be determined by a fixed clock. Single edge modulation prevents double pulsing, a typically undesirable event, from happening because the modulator can do only one thing—turn the output either off or on. Depending on which edge of each pulse is used, the two schemes for single edge modulation are referred to as either leading edge or trailing edge modulation. Neither is ideal for maintaining good regulation when the load is subject to large transients. Leading edge modulation provides good performance for light load conditions (in which positive transients are dominant), but is not as responsive for heavy load conditions (in which negative transients are dominant). Alternately, trailing edge modulation provides good performance for heavy load conditions, but is not so responsive for light load conditions.

Another approach that has been used in PWM switching regulators is dual edge modulation. In dual edge modulation, as the name suggests, both edges of a pulse signal are modulated. This is typically accomplished by comparing an error signal to a triangle waveform. Still, dual edge modulation requires double pulse protection, which is accomplished by allowing only one state change for each slope on the triangle waveform. In other words, during half of each cycle, the modulator can turn the switch on but not off. During the other half, the modulator does the opposite. Therefore, compared to leading edge modulation, dual edge modulation performs somewhat worse for positive load transients but much better for negative load transients. Compared to trailing edge modulation, dual edge modulation performs much better for positive load transients but somewhat worse for negative load transients.

As such, none of the previously developed techniques achieve optimum response for all transient conditions for a switching regulator.

### SUMMARY

According to an embodiment of the present invention, in a power converter system having a load, a method is provided for varying the type of modulation employed for a pulse width modulation (PWM) signal. The method includes the following: monitoring the load of the power converter system; using leading edge modulation for the PWM signal under light load condition; and using trailing edge modulation for the PWM signal under heavy load condition; thereby optimizing operation of the power converter system.

According to another embodiment of the present invention, a power converter system includes an output terminal at which power is provided to a load. The system also includes a power switch for which a pulse width modulation (PWM) is developed for delivering power to the load. Monitoring circuitry, coupled to the output terminal, monitors the load. Other circuitry, coupled to the monitoring circuitry, causes leading edge modulation to be used for the PWM signal under light load condition and trailing edge modulation to be used for the PWM signal under heavy load condition, thereby optimizing operation of the power converter system.

Important technical advantages of the present invention are readily apparent to one skilled in the art from the following figures, descriptions, and claims.

### BRIEF DESCRIPTION OF DRAWINGS

For a more complete understanding of the present invention and for further features and advantages, reference is now made to the following description taken in conjunction with the accompanying drawings.

FIGS. 1A-1C are waveform diagrams for various modulation techniques which are implemented in embodiments of the present invention.

FIG. 2 is a schematic diagram of one implementation for a power converter system with variable edge modulation, according to an embodiment of the invention.

FIG. 3 is a schematic diagram of an implementation for an oscillator circuit with control, according to an embodiment of the invention.

FIG. 4 is a schematic diagram of another implementation for a power converter system with variable edge modulation, according to an embodiment of the invention.

### DETAILED DESCRIPTION

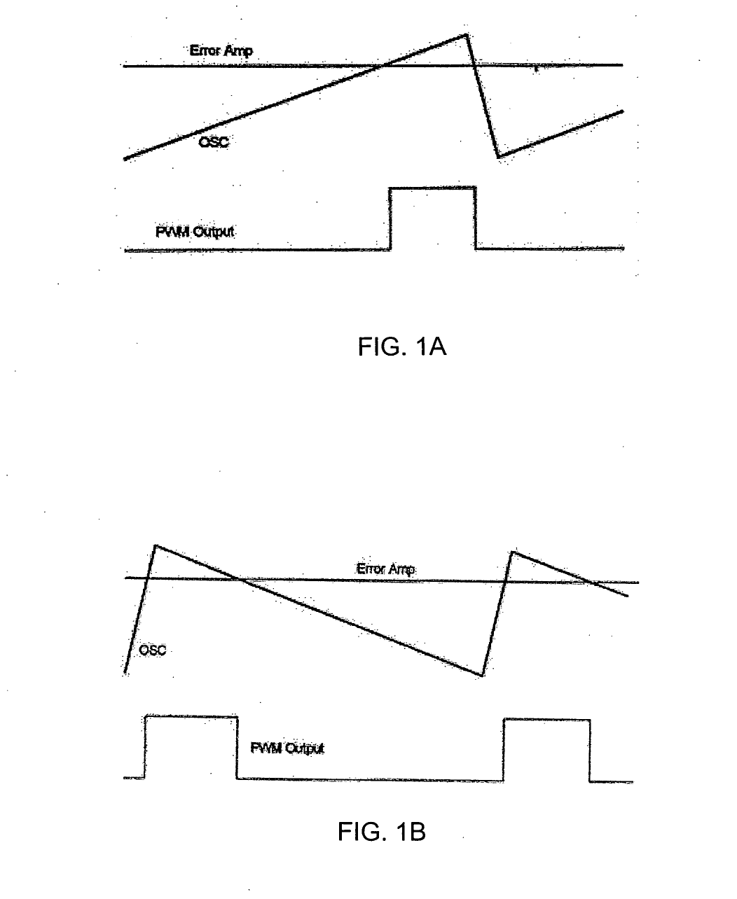

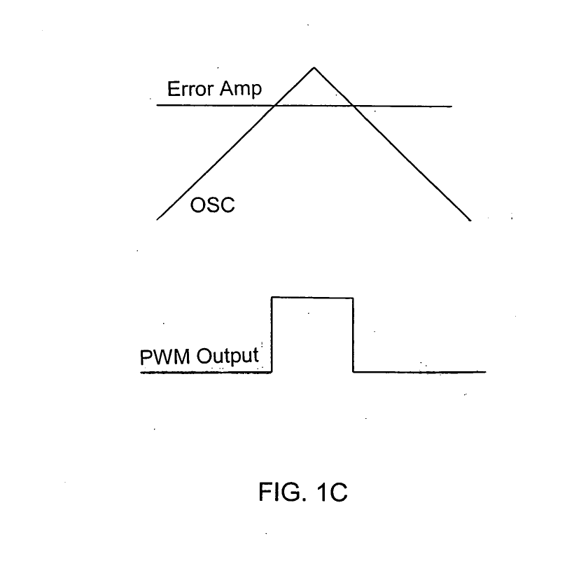

Embodiments of the present invention and their advantages are best understood by referring to FIGS. 1A through 4 of the drawings. Like numerals are used for like and corresponding parts of the various drawings.

The present invention applies to switching regulators that must maintain good regulation when the load is subject to large transients. Large transients can be problematic in inductor-based switching regulators, because the change in load current (dI/dt) will typically be much larger than can be supplied through the inductor (where dI/dt=V/L). To make up for this difference, switching regulators should have enough output capacitance to maintain the regulated voltage within specification. Such output capacitors can be costly and take up considerable space on a printed circuit board (PCB). When confronted with the demand of increased load current transients, one way to handle them is to increase the output capacitance of the switching regulator. This adds more cost and consumes more space on the PCB. Alternatively, another way is to decrease the inductor value to accelerate the recovery, but this will produce increased ripple, which in turn requires a higher switching frequency. Such an approach reduces efficiency of the switching regulator.

Regardless of the final choice of frequency, inductor, and output capacitance, any power system could be improved if the response time of the switching regulator is optimized. However, power systems implementing the previously known modulation techniques have an inherent time delay for certain kinds of transients. This added time delay (which falls between the load transient and the regulator's response) requires more output capacitance to maintain regulation. An example of a modulation time delay is one that may occur in a leading edge modulation system experiencing a full scale negative load transient (i.e., from supplying full power to zero power) which may happen immediately after the leading edge modulator has turned on the output transistor. Until the transistor is turned off, it will continue to ramp up inductor current even when the load is decreasing. No matter how fast the control loop responds, it cannot turn the transistor off until the trailing edge clock arrives.

In various embodiments, systems and methods are provided in which the type of modulation (e.g., leading edge, trailing edge, or dual edge) used in a switching regulator is changed on the fly, for example, as a function of load current. When the load changes, the type of modulation changes. This can optimize the configuration of the switching regulator to provide the best possible response for that specific load condition, thus allowing for a cost reduction in the output capacitance for the switching regulator. In particular, leading edge modulation is utilized for light load conditions (in which positive transients are dominant) and trailing edge modulation is utilized for heavy load conditions (in which negative transients are dominant). This can be accomplished by changing the type of modulation from leading edge to trailing edge as the load changes. This technique takes advantage of the fact that a large negative transient can not occur in a switch regulator under light load condition, and conversely, a large positive transient can not occur in a switch regulator under full load condition.

In one embodiment, a power converter system (and corresponding methods) can behave like a leading edge modulation system at light load, and gradually change to a trailing edge modulation system at full load, acting much like the dual edge modulation system of previously developed designs at half load. This can be implemented by starting with a dual edge system topology and modifying the triangle wave generator so that it produces a left-handed sawtooth waveform at light load, a triangle waveform at half (or 50%) load, and a right-handed sawtooth waveform at full load.

In another embodiment, the power converter system (and corresponding methods) use leading edge modulation when the load is in the 0 to 50% range and abruptly switches to trailing edge modulation when the load is above 50%. In practice some hysteresis is typically added to prevent mode change oscillations. For example, the system may stay in leading edge modulation up to 60% of full load when the load is increasing from light load; but after the transition, the power converter system remains in trailing edge modulation down to 40% of full load before switching back.

FIGS. 1A-1C are waveform diagrams for various modulation techniques which are implemented in embodiments of the present invention.

The modulator waveforms for light load condition are shown in FIG. 1A. Here, the power converter system (and methods) output a forward (left-handed) sawtooth waveform as the ramp oscillator signal (OSC). This gives priority to the rising edge of the PWM output pulse width. The output from the error amplifier drops when a positive load step occurs, thus momentarily increasing the pulse width of the PWM output from the system. Because the ramp oscillator signal is asymmetrical, most of the increase in duty cycle will come from the leading edge of the pulse (i.e., the pulse begins at an earlier moment in time because the lower value for the error amplifier signal would cause it to intersect the oscillator signal earlier).

The modulator waveforms for full load condition are shown in FIG. 1B. Here, the slopes of the ramp oscillator signal (OSC) are reversed compared to the light load condition. Here, the power converter system (and methods) output a backward (right-handed) sawtooth waveform. This gives priority to the trailing edge of the PWM output pulse width. The output from the error amplifier increases when a negative load step occurs, thus momentarily decreasing the pulse width of the PWM output from the system. Most of the decrease in duty cycle will come from the trailing edge of the pulse (i.e., the pulse ends at an earlier moment in time because the higher value for the error amplifier signal would cause it to intersect the oscillator signal earlier).

The modulator waveforms for half load (e.g., 50% of full load) condition, for some embodiments, are shown in FIG. 1C. The power converter system (and methods) outputs a triangle waveform for the oscillator ramp signal (OSC). This gives equal weight to positive or negative transients. The OSC waveform in this embodiment tracks the load such that, for example, at 25% of full load, the ratio of rise and fall ramps is 75:25; at half load, the ratio is 50:50; and at 75% of full load, the ratio is 25:75. The oscillator may be designed to ensure constant frequency versus the load, which is normally good practice.

In some embodiments, the triangle waveform for the oscillator ramp signal (OSC) is not used. Rather, leading edge modulation is used when the load is in the 0 to 50% range and trailing edge modulation is used when the load is above 50%. Although this approach is not as optimized embodiments which transition from leading edge to triangle to trailing edge, it is adequate for most power converter systems because the transients at the midway (50%) point are not as severe.

The variable edge modulation system is implemented with a dual edge architecture since it needs to respond to both slopes of the oscillator signal. Switching frequency is typically set by the oscillator. On the other hand, single edge modulation architectures use a system clock to pre-set one edge and the ramp or error amplifier modulator to set the other edge. A sawtooth oscillator is typically used to provide the desired maximum range. For example, in a system in which the duty cycle is desirably limited to a maximum of 85%, a ramp-slope ratio of 85:15% is used. Previously developed systems use one type of modulation for all load conditions. This results in systems that are optimized for only one type of transient. In some embodiments, both single edge modulation types are used to achieve the optimum transient response at light and full loads.

In some embodiments, single edge modulation, rather than dual edge modulation, can be used. For this, the waveforms would be similar to those in FIGS. 1A and 1B except that a clock signal would be used to define one edge of the pulse instead of the fast slope of oscillator signal (i.e., the falling edge of forward sawtooth waveform, or the rising edge of the backward sawtooth waveform). Here, the ramp signal is slaved or synchronous to the clock signal—i.e., the clock timing versus the ramp is fixed at the fast slope. Compared to a dual edge system, the single edge modulation system (with the clocked sawtooth signal) differs in that the timing of the fast edge would not move at all with a change in the error amplifier. Ideally the system would switch between leading edge and trailing edge somewhere near the midpoint of the range from light to full load. Hysteresis could be used at the load current switch point to eliminate mode switching jitter. However, other factors, such as supply voltage, may make it desirable to have a switch-over point that is not at the midpoint of the load range.

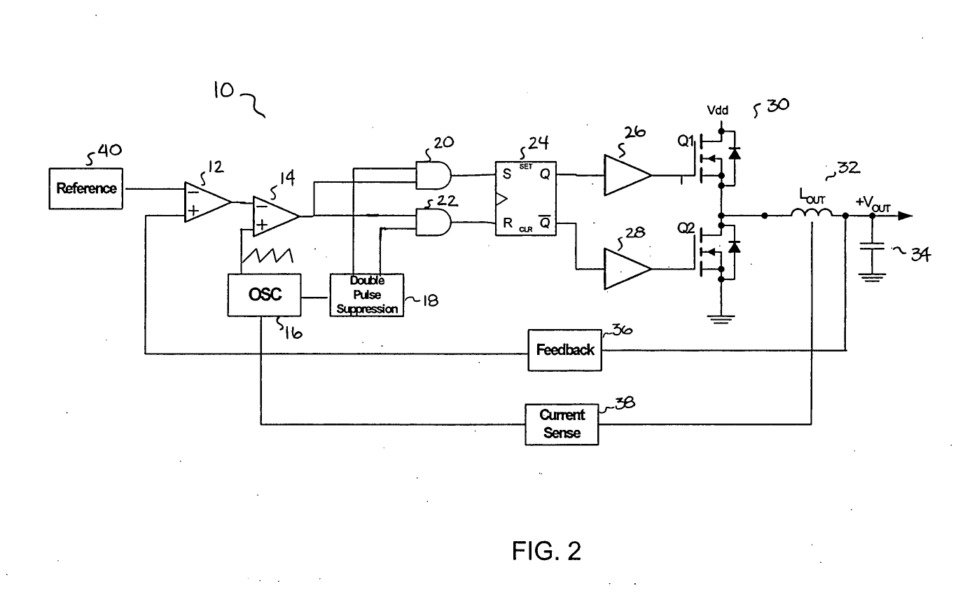

FIG. 2 is a schematic diagram of a power converter system 10 with variable edge modulation, according to an embodiment of the invention. Power converter system 10 is a switching regulator and can provide a direct current (DC) power. Power converter 10 can be incorporated in or used with any electronic device in which a DC-to-DC converter as described herein is needed. Power converter system 10 receives an input voltage Vin (as Vdd) and provides the DC power to a load at an output terminal Vout. In one embodiment, power converter system 10 can be a synchronous buck converter which convert a voltage at a higher level (e.g., 5V) to a voltage at a lower level (e.g., 1V). In other embodiments, power converter system 10 can be a boost or buck-boost converter (not shown). Upon reading this disclosure, a skilled artisan can understand how to implement the present invention without undue experimentation. As shown, power converter system 10 includes an error amplifier 12, a pulse width modulation (PWM) comparator 14, an oscillator circuit 16, a double pulse suppression circuit 18, AND gates 20, 22, latch 24, drivers 26, 28, a power output circuit 30, an inductor 32, an output capacitor 34, a feedback circuit 36, an inductor current sense circuit 38, and reference circuit 40.

The inductor 32 is coupled to the output capacitor 34 at the output terminal of the power converter system 10. As used herein, the terms “coupled” or “connected,” or any variant thereof, covers any coupling or connection, either direct or indirect, between two or more elements. Output capacitor 34 protects against transients in the load. The power output circuit 30 is coupled to the inductor 32. Power output circuit 30 may comprise one or more switches which are turned on and off to ramp up and down the current of inductor 32, thus controlling or regulating the output voltage Vout at the output terminal of power converter system 10.

In one implementation, power output circuit 30 may comprises two switches (referred to as Q1, Q2) connected at a switching node (SW) in a half-bridge arrangement, with one switch (Q1) being the “high-side” switch and the other switch (Q2) being the “low-side” switch. The high-side switch may be connected between the input voltage Vin (Vdd) and node SW. The low-side switch may be connected between the node SW and ground (GND), and provides or supports synchronous rectification. For synchronous rectification, the low-side switch is turned off during the charge cycle for inductor 32, and turned on as inductor 32 discharges into the load. Each of the two switches can be implemented with any suitable device, such as, for example, a metal-oxide-semiconductor field effect transistor (MOSFET), an IGBT, a MOS-gated thyristor, or other suitable power device. Each switch has a gate to which driving voltage may be applied to turn the switch on or off.

Error amplifier 12, PWM comparator 14, oscillator circuit 16, double pulse suppression circuit 18, AND gates 20, 22, latch 24, drivers 26, 28, feedback circuit 36, inductor current sense circuit 38, and reference circuit 40 implement control and drive circuitry which is connected to the gates of the high-side and low-side switches, and outputs control signals for turning on and off the switches.

Feedback circuit 36 monitors the output of the power converter system 10, and provides a feedback signal (which proportional to the output) to the error amplifier 12. The feedback circuit 36 may comprise frequency dependent compensation circuits that are responsible for maintaining stability in the control system. Error amplifier 12 compares the output signal from the feedback circuit 36 against a reference signal provided by the reference block 40. The error amplifier 12 generates at its output an error signal, Verr, which is the amplified difference between the reference voltage and the output after feedback compensation.

Current sense circuit 38 measures the current flowing through inductor 32. In one embodiment, current sense circuit 38 is implemented using a sense resistor or calibrated trace resistance which directly measures the inductor current. In another embodiment, current sense circuit 38 measures the current flow through inductor 32 indirectly, for example, by measuring the voltage on the drain of the synchronous rectifier (low-side switch), which equals the current of the inductor 32×RDSon, or by measuring the drop across the equivalent series resistance (ESR) of the inductor 32 with a low-pass filter (LPF). The amount of current flowing through inductor 32 is commensurate with the load on power converter system 10. In steady state, the inductor current equals the load current, but not immediately after a transient because the inductor takes time to respond. The output capacitor 34 then must hold the voltage until the inductor catches up. For this, the error amplifier 12 responds to the output error that results, and changes the duty cycle. Current sense circuit 38 outputs a signal which is provided to oscillator circuit 16.

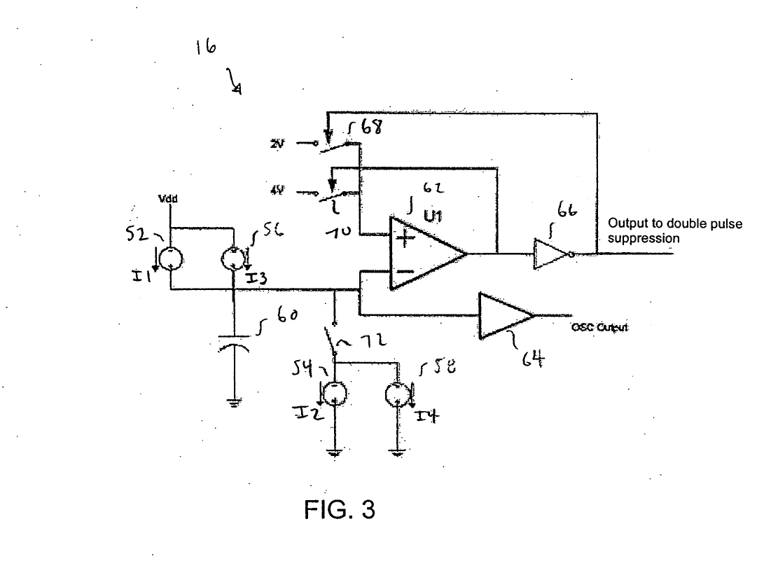

Oscillator circuit 16 generates one or more timing signals. These timing signals can have various forms including, for example, a forward (left-handed) sawtooth waveform, a backward (right-handed) sawtooth waveform, or a triangle waveform. The form of the timing signal output from oscillator circuit 16 may be responsive to the signal from current sense circuit 38. For example, in one embodiment, oscillator circuit 16 outputs a forward (left-handed) sawtooth waveform when inductor current is light (corresponding to light load condition), and outputs a backward (right-handed) sawtooth waveform when the inductor current is greater under full (or heavy) load condition. The implementation for oscillator circuit 16 would be understood to one of ordinary skill in the art based on the teachings herein. An exemplary implementation for oscillator circuit 16 is shown and described with reference to FIG. 3. The timing signal from oscillator circuit 16 is provided to PWM comparator 14 for modulation of the duty cycle. Oscillator circuit 16 also provides a signal to the double pulse suppression circuit 18.

Double pulse suppression circuit 18 generates a separate signal for each AND gate 20 and 22 to enable or disable the same. These signals are complimentary and coincident with the ramp waveforms switching states at the peak and valley of the oscillator signal. In the embodiment of FIG. 2, which generates the leading edge of the PWM pulse when the oscillator output ramps higher than the error voltage Verr, the double pulse suppression circuit 18 enables AND gate 20 with a logic 1 from the low point to the high point of the ramp and at the same time disables AND gate 22 with a logic 0. This allows the PWM comparator 14 to set latch 24, but prevents any attempt to reset the latch 24 until the oscillator ramp changes phase. This effectively prevents the PWM comparator 14 from toggling the latch 24 even if noise in the system propagates to the output of the PWM comparator 14. Some amount of response time may be sacrificed for this noise suppression. In other words, after the latch 24 is set, if a negative load transient occurs and the error amplifier 12 and PWM comparator 14 respond before the oscillator 16 changes phase, latch 24 will be inhibited from being reset until the enable signal for AND gate 22 changes to a logic 1. While this response is not as fast as would be achieved with trailing edge modulation, it is better than would be delivered by a leading edge system. Embodiments of the power converter system 10 can be configured to provide the best response of both leading and trailing edge systems while maintaining double pulse noise immunity. The latch circuit 24 is connected to the AND gates 20 and 22. The latch circuit 24, as shown, can be implemented as a set-reset (SR) flip-flop. The set input of the latch circuit 24 receives the output from AND gate 20, and the reset input receives the output from AND gate 22. The output (Q) of the latch circuit 24 is provided to drivers 26 and 28 to drive the switches of power output circuit. Drivers 26 and 28 are simplified in this diagram. In some embodiments, the drivers 26 and 28 are interconnected with timing and safety features that perform functions such as, for example, dead time control which prevents cross conduction in the two switches (e.g., Q1, Q2) of power output circuit 30.

PWM comparator 14 compares the output from the error amplifier 12 against the timing signal from the oscillator circuit 16 to generate a PWM signal, which is a modulated signal having varying pulse widths. The PWM comparator 14 connects to both the set and reset inputs of latch circuit 24 to provide variable edge response. Latch 24 is set when the PWM comparator 14 detects that the ramp exceeded the Verr signal output from the error amplifier 12 and AND gate 20 is enabled (indicating a positive ramp). Latch 24 is reset when the oscillator ramp falls below the Verr signal and AND gate 22 is enabled (indicating a negative ramp).

In various embodiments, all or a portion of power converter system 10 can be implemented on a single or multiple semiconductor dies (commonly referred to as a “chip”) or discrete components. Each die is a monolithic structure formed from, for example, silicon or other suitable material. For implementations using multiple dies or components, the dies and components can be assembled on a printed circuit board (PCB) having various traces for conveying signals therebetween. In one embodiment, power output circuit 30 is implemented on one die; error amplifier 12, PWM comparator 14, oscillator circuit 16, double pulse suppression circuit 18, AND gates 20, 22, latch 24, drivers 26, 28, feedback circuit 36, inductor current sense circuit 38, and reference circuit 40 are implemented on another die; and the inductor 32 and output capacitor 34 are discrete components.

According to various embodiments, the present invention provides variable edge modulation in power converter system 10, which optimizes the configuration of the system to deliver the best possible response for a specific load condition. In particular, leading edge modulation is utilized for light load conditions (in which positive transients are dominant) and trailing edge modulation is utilized for heavy load conditions (in which negative transients are dominant). This can be accomplished by changing the type of modulation from leading edge to trailing edge as the load changes. This technique takes advantage of the fact that a large negative transient will generally not occur in a switch regulator under light load condition, and conversely, a large positive transient will generally not occur in a switch regulator under full load condition.

With the implementation shown in FIG. 2, power converter system 10 can behave like a leading edge modulation system at light load, and gradually change to a trailing edge modulation system at full load, acting much like a dual edge modulation system at half load.

In particular, under light load condition, oscillator circuit 16 outputs a forward (left-handed) sawtooth waveform. This gives priority to the rising edge of the PWM output pulse width. The output from error amplifier 12 drops when a positive load step occurs, thus momentarily increasing the pulse width of the PWM signal from PWM comparator 14. Under full load condition, oscillator circuit 16 outputs a backward (right-handed) sawtooth waveform. This gives priority to the trailing edge of the PWM output pulse width. The output from error amplifier 12 drops when a negative load step occurs, thus momentarily increasing the pulse width of the PWM signal from PWM comparator 14. Under half load (e.g., 50% of full load) condition, for oscillator 16 outputs a triangle waveform for the oscillator ramp signal. This gives equal weight to positive or negative transients.

FIG. 3 is a schematic diagram of an implementation for oscillator circuit 16, according to an embodiment of the invention. As shown, oscillator circuit 16 comprises current sources 52, 54, 56, 58, capacitor 60, comparator 62, buffer circuit 64, inverter circuit 66, and switches 68, 70, 72.

Oscillator circuit 16 can be formed from a basic sawtooth oscillator circuit with modification. The basic sawtooth oscillator is made from current sources 52 and 54, providing respective currents I1 and I2, that charge and discharge capacitor 60 at different rates. The slopes of the rising and falling ramps of the voltage on capacitor 60 are proportional to the currents I1 and I2. The modification is the addition of current sources 56 and 58, providing respective currents I3 and I4. The currents I3 and I4 are dependent or responsive to the load and can be controlled, for example, by signals from the current sense circuit 38. With the addition of load dependent current sources 56 and 58, the modified sawtooth oscillator circuit 50 produces or outputs the variable slope waveforms shown in FIGS. 1A-1C. In some embodiments, in order to maintain constant frequency, the currents I3 and I4 are not linearly dependent on the load. This can be accomplished in various ways, both analog and digital, for example, using a look up table and DAC, or a multiplier for the control.

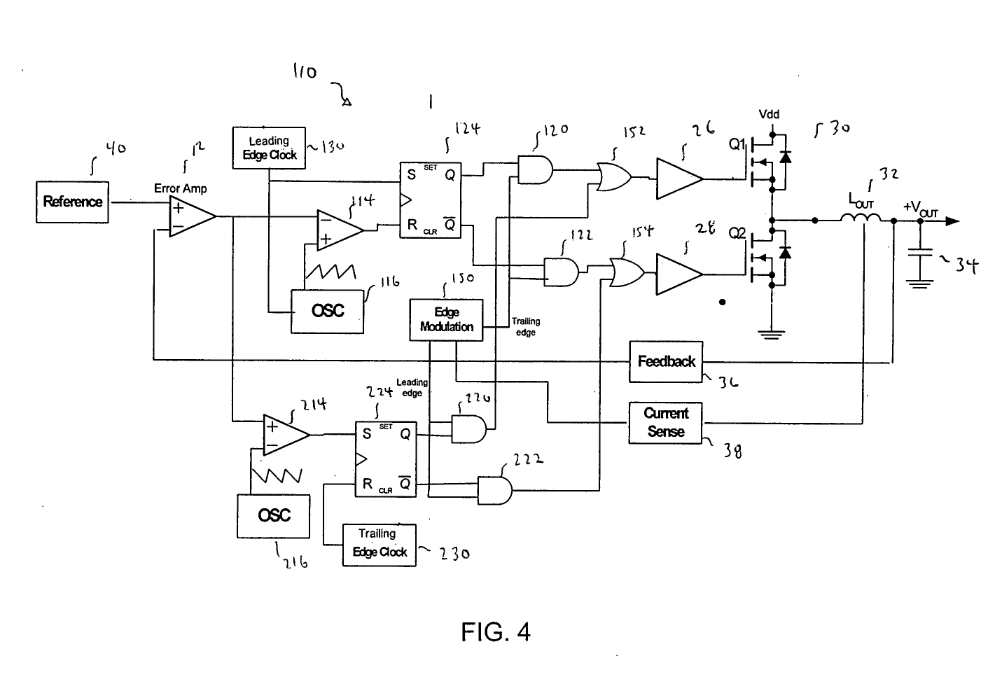

FIG. 4 is a schematic diagram of another implementation for a power converter system 110 with variable edge modulation, according to an embodiment of the invention. Like power converter system 10 in FIG. 2, power converter system 110 is a switching regulator and can provide a direct current (DC) power. Power converter system 110 receives an input voltage Vin (as Vdd) and provides the DC power to a load at an output terminal Vout. As shown, power converter system 110 includes error amplifier 12, pulse width modulation (PWM) comparators 114, 214, oscillator circuits 116, 216, trailing edge clock circuit 130, leading edge clock circuit 230, AND gates 120, 122, 220, 222, edge modulation circuit 150, OR gates 152, 154, latches 124, 224, drivers 26, 28, power output circuit 30, inductor 32, output capacitor 34, feedback circuit 36, inductor current sense circuit 38, and reference circuit 40.

Power converter system 110 in FIG. 4 operates similar to power converter system 10 in FIG. 2, except that instead of using a dual edge modulator and gradually transitioning priority from leading edge modulation to trailing edge modulation, power converter system 110 uses multiple single edge modulators (in this embodiment there are two modulators—a leading edge modulation when the load is in the 0 to 50% range, and a trailing edge modulation when the load is above 50%.)

To accomplish this, power converter system 110 has one set of circuitry for leading edge modulation and another set of circuitry for trailing edge modulation.

The trailing edge modulation circuitry includes the PWM comparator 114, oscillator circuit 116, trailing edge clock circuit 130, latch 124, and AND gates 120, 122. The oscillator circuit 116 generates a forward sawtooth waveform which is provided to the PWM comparator 114 for trailing edge modulation of the PWM signal. The leading edge clock circuit 130 generates a clock signal for the leading edge of the PWM signal by setting latch 124, and it initiates the start of oscillator ramp. The PWM signal is terminated when the ramp crosses the error voltage. The Q output of latch 124 is therefore a trailing edge modulated PWM signal that is passed to the output if AND gates 120 and 122 are enabled.

Similarly, the leading edge modulation circuitry includes the PWM comparator 214, oscillator circuit 216, trailing edge clock circuit 230, latch 224, and AND gates 220, 222. The oscillator circuit 216 generates a backward sawtooth waveform which is provided to the PWM comparator 214. PWM comparator 214 is connected to the set input of latch 224, which determines the start or leading edge of the PWM signal when the ramp goes below the error voltage. The trailing edge clock circuit 230 generates a clock signal for the trailing edge of the pulses which resets latch 224 and terminates the ramp.

Edge modulation circuit 150 receives the signal from current sense circuit 38 and outputs signals for selecting either the leading edge modulated PWM signal (generated by the leading edge modulation circuitry) or the trailing edge modulated PWM signal (generated by the trailing edge modulation circuitry). The leading edge modulated PWM signal can be selected when there is relatively light load (i.e., all load currents below 50%) on the power converter system 110. The trailing edge modulated PWM signal can be selected when there is relatively heavy load (i.e., all load currents above 50%) on power converter system 110. The output signal from edge modulation circuit 150 enable either AND gates 120 and 122, or alternately, AND gates 220 and 222. Edge modulation circuit 150 can be implemented digitally or in analog, as would be understood by one of ordinary skill.

Although the present invention and its advantages have been described in detail, it should be understood that various changes, substitutions, and alterations can be made therein without departing from the spirit and scope of the invention as defined by the appended claims. That is, the discussion included in this application is intended to serve as a basic description. It should be understood that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Neither the description nor the terminology is intended to limit the scope of the claims.

What is claimed is:

1. In a power converter system having a load, a method for varying the type of modulation employed for a pulse width modulation (PWM) signal, the method comprising:
monitoring the load of the power converter system;
using leading edge modulation for the PWM signal under light load condition; and
using trailing edge modulation for the PWM signal under heavy load condition;
thereby optimizing operation of the power converter system.

2. The method of claim 1 comprising using dual edge modulation to modulate the pulses of the periodic signal under medium load condition.

3. The method of claim 1 wherein monitoring comprises sensing load current in the power converter system.

4. The method of claim 1 comprising generating a forward sawtooth waveform for leading edge modulation.

5. The method of claim 1 comprising generating a backward sawtooth waveform for trailing edge modulation.

6. The method of claim 1 wherein there is a gradual change from one type of edge modulation to other as the load changes.

7. The method of claim 1 wherein there is an abrupt change from one type of edge modulation to other as the load changes.

8. The method of claim 1 wherein leading edge modulation is used when the load is in the 0 to 50% range and trailing edge modulation is used when the load is above 50%.

9. A power converter system comprising:
an output terminal at which power is provided to a load;
a power switch for which a pulse width modulation (PWM) is developed for delivering power to the load;
monitoring circuitry coupled to the output terminal for monitoring the load; and
circuitry coupled to the monitoring circuitry for causing leading edge modulation to be used for the PWM signal under light load condition and trailing edge modulation to be used for the PWM signal under heavy load condition, thereby optimizing operation of the power converter system.

10. The power converter system of claim 9 wherein the monitoring circuitry comprises circuitry for sensing load current.

11. The power converter system of claim 9 comprising an inductor coupled to the power switch and through which current flows to the load.

12. The power converter system of claim 11 wherein the monitoring circuitry comprises circuitry for sensing the current flowing through the inductor.

13. The power converter system of claim 9 comprising an oscillator circuit operable to generating a forward sawtooth waveform for leading edge modulation and to generate a backward sawtooth waveform for trailing edge modulation.

14. The power converter system of claim 9 comprising:
a first oscillator circuit operable to generate a forward sawtooth waveform for leading edge modulation; and
a second oscillator circuit operable to generate a backward sawtooth waveform for trailing edge modulation.

15. The power converter system of claim 9 wherein there is a gradual change from one type of edge modulation to other as the load changes.

16. The power converter system of claim 9 wherein there is an abrupt change from one type of edge modulation to other as the load changes.

17. The power converter system of claim 9 wherein leading edge modulation is used when the load is in the 0 to 50% range and trailing edge modulation is used when the load is above 50%.

18. A power converter system comprising:
an output terminal at which power is provided to a load;
a power switch for which a pulse width modulation (PWM) is developed for delivering power to the load;
means for monitoring the load; and
means for causing leading edge modulation to be used for the PWM signal under light load condition and trailing edge modulation to be used for the PWM signal under heavy load condition, thereby optimizing operation of the power converter system.

19. The power converter system of claim 18 wherein the monitoring circuitry comprises circuitry for sensing load current.

20. The power converter system of claim 18 comprising means for generating a forward sawtooth waveform for leading edge modulation and for generating a backward sawtooth waveform for trailing edge modulation.

21. The power converter system of claim 18 wherein there is a gradual change from one type of edge modulation to other as the load changes.

22. The power converter system of claim 18 wherein there is an abrupt change from one type of edge modulation to other as the load changes.

23. An integrated circuit for a power converter system, the integrated circuit comprising:
a power switch for which a pulse width modulation (PWM) is developed for delivering power to a load at an output terminal;
monitoring circuitry coupled to the output terminal for monitoring the load; and
circuitry coupled to the monitoring circuitry for causing leading edge modulation to be used for the PWM signal under light load condition and trailing edge modulation to be used for the PWM signal under heavy load condition, thereby optimizing operation of the power converter system.

24. The integrated circuit of claim 23 wherein the monitoring circuitry comprises circuitry for sensing load current.

25. The integrated circuit of claim 23 wherein the monitoring circuitry comprises circuitry for sensing current flowing through an inductor of the power converter system.

26. The integrated circuit of claim 23 comprising an oscillator circuit operable to generating a forward sawtooth waveform for leading edge modulation and to generate a backward sawtooth waveform for trailing edge modulation.

27. The integrated circuit of claim 23 comprising:
a first oscillator circuit operable to generate a forward sawtooth waveform for leading edge modulation; and
a second oscillator circuit operable to generate a backward sawtooth waveform for trailing edge modulation.

28. The integrated circuit of claim 23 wherein leading edge modulation is used when the load is in the 0 to 50% range and trailing edge modulation is used when the load is above 50%.
